(19) United States
(12) Patent Application Publication
(10) Pub. No.: US 2007/0222831 A1
(43) Pub. Date: Sep. 27, 2007

(54) Liquid send/receive joint device and fuel cell system using the same

(75) Inventors: Toru Takahashi, Sagamihara-shi (JP); Nobuo Katsuura, Yokohama-shi (JP); Makoto Ebikawa, Sagamihara-shi (JP); Junji Oyama, Sagamihara-shi (JP)

Correspondence Address: NIXON PEABODY, LLP, 401 9TH STREET, NW, SUITE 900, WASHINGTON, DC, 20004-2128, US

(73) Assignee: NIX, INC.

(21) Appl. No.: 11/723,257

(22) Filed: Mar. 19, 2007

(30) Foreign Application Priority Data
Mar. 22, 2006 (JP) 2006-078339

(51) Int. Cl. B41J 2/175

(52) U.S. Cl. 347/85

(57) ABSTRACT

A liquid send/receive joint device that allows for a wide range of connection positions of a liquid reservoir and a liquid accepter when they are connected, that can always maintain a good connection between the liquid reservoir and the liquid accepter, and that can send/receive a liquid safely and with certainty; and a fuel cell system equipped with this liquid send/receive joint device. A liquid send/receive joint device 1 includes: a reservoir-side joint member 10 that can be attached to a liquid reservoir 100; and an accepter-side joint member 50 that can be attached to a liquid accepter 200 and connected to the reservoir-side joint member 10 in such a manner that the accepter-side joint member 50 can be attached to or detached from the reservoir-side joint member 10 whenever necessary; wherein the reservoir-side joint member 10 and the accepter-side joint member 50 are connected to each other via a spherical joint mechanism.

### CROSS-REFERENCE TO RELATED APPLICATIONS

This application relates to and claims priority from Japanese Patent Application No. JP 2006-78339, filed on Mar. 22, 2006, the entire disclosure of which is incorporated herein by reference.

### BACKGROUND

1. Technical Field

The invention relates to a liquid send/receive joint device for guiding a liquid from a liquid reservoir to a liquid accepter for receiving the liquid in a liquid supply means for, for example, a fuel cell or an ink-jet printer. This invention also relates to a fuel cell system equipped with such a liquid send/receive joint device.

2. Related Art

A liquid supply means to which a liquid reservoir containing and discharging a liquid, and a liquid accepter for receiving the liquid from the liquid reservoir can be attached is now widely used in, for example, ink-jet printers, lighters using liquid fuel, and chemical liquid administration for medical treatment. In the liquid supply means, the liquid reservoir itself can be directly replaced when it runs short of the liquid to be supplied. Accordingly, compared to the case where the liquid is supplied directly to, for example, a reserve tank mounted on a main body of the liquid supply means, users can supply the liquid to the liquid reservoir more easily and safely without dirtying their hands as much with the liquid. In particular, this liquid supply means is very effective where the liquid to be supplied has an effect on the human body or may severely deteriorate if exposed to air.

Also, the development of fuel cells that generate electric power by using a liquid as fuel is being promoted these days. In particular, many electric-appliance makers are actively promoting the development of direct methanol fuel cells (DMFC), which use methanol as fuel. The DMFCs are expected to be new, next-generation batteries that can be used for, for example, notebook personal computers, various portable electronics, and cell phones. However, in general, methanol has a considerable effect on the human body. If a human inhales methanol, it may damage the central nervous system and cause dizziness and diarrhea. If a human inhales a large amount of methanol or methanol enters his eyes, the methanol may cause an optic nerve disorder and there is a high possibility of loss of sight. Accordingly, methanol is a highly dangerous toxic liquid. Therefore, in order to safely and easily supply fuel to general consumers of DMFCs, a means of supplying methanol to a liquid reservoir using a cartridge, without directly touching the methanol, is considered to be the optimum means, and the development of such means is being widely promoted. (See, for example, JP2003-308871 A, JP8-12301 A, and JP2003-317756 A).

The above-described liquid supply means needs to have a liquid send/receive joint device that guides the liquid from a liquid reservoir to a liquid accepter and can be attached to the liquid reservoir and/or the liquid accepter. Various types of conventional joint devices have been introduced. (See, for example, JP10-789 A, JP8-50042 A, JP 2003-528699 T, JP2003-266739 A, JP2001-524896 T, JP2000-289225 A, JP7-68780 A, JP5-254138 A, and JP2003-331879 A).

However, when the conventional liquid send/receive joint device sends and receives the liquid by connecting the liquid reservoir with the liquid accepter, it is necessary to keep the liquid reservoir, the liquid send/receive joint device, and the liquid accepter at specified connection positions. Accordingly, using snap hooks (snap-fit units) as a retention mechanism for the joint device has been suggested. However, since conventional liquid send/receive joint devices have a low tolerance for external force applied in a direction substantially perpendicular to the direction in which the liquid reservoir is connected with the liquid accepter, their connection positions may sometimes be displaced (or changed), thereby making it difficult to properly keep the connection between the liquid reservoir and the liquid accepter via the liquid send/receive joint device. As a result, there is a possibility that sending/receiving the liquid may be disturbed.

### SUMMARY

The present invention was devised in light of the circumstances described above. It is an object of the invention to provide a liquid send/receive joint device that allows for a wide range of connection positions of the liquid reservoir and the liquid accepter when they are connected via a liquid send/receive joint device, that can maintain a good connection between the liquid reservoir and the liquid accepter even if the positional relationship between the liquid reservoir and the liquid accepter changes (or is displaced), and that can send/receive a liquid safely and with certainty. It is another object of the invention to provide a fuel cell system equipped with the liquid send/receive joint device described above.

In order to achieve the above-described objects, a liquid send/receive joint device for connecting a liquid reservoir containing a liquid to a liquid accepter for receiving the liquid from the liquid reservoir is provided according to an aspect of the invention. The liquid send/receive joint device includes: a reservoir-side joint member that can be attached to the liquid reservoir; and an accepter-side joint member that can be attached to the liquid accepter and connected to the reservoir-side joint member in such a manner that the accepter-side joint member can be attached to or detached from the reservoir-side joint member whenever necessary; wherein the reservoir-side joint member and the accepter-side joint member are connected to each other via a spherical joint mechanism.

In the liquid send/receive joint device having the above-described structure, the reservoir-side joint member and the accepter-side joint member are connected to each other via the spherical joint mechanism. Accordingly, even if the positional relationship between the liquid reservoir and the liquid accepter is changed (or displaced) when the liquid reservoir and the liquid accepter are connected to each other, the spherical joint mechanism allows for the change in their positions. As a result, even if external force is applied to the liquid send/receive joint device in a direction substantially perpendicular to the direction in which the liquid reservoir is connected to the liquid accepter, it is possible to maintain a good connection between the liquid reservoir and the liquid accepter.

The spherical joint mechanism in the liquid send/receive joint device according to the invention can include: a spherical protrusion formed on either of the reservoir-side joint member or the accepter-side joint member; and a spherical recess formed in the other of the two joint members that does not have the spherical protrusion, wherein the spherical protrusion is of a shape complementary to the spherical protrusion.

Moreover, in the liquid send/receive joint device according to the invention, a seal member can be provided in at least one of the spherical protrusion and the spherical recess. In addition to the advantageous effects described above, providing the seal member can keep an area between the spherical protrusion and the spherical recess watertight and prevent liquid leakage with more certainty.

When placing the seal member on the spherical protrusion, the seal member is preferably placed at a position slightly off-center on the spherical protrusion. When placing the seal member in the spherical recess, it is more desirable that the seal member be placed at a position slightly off-center on the spherical recess. As a result, a better sealing effect can be achieved.

Incidentally, the seal member can be placed in both the spherical protrusion and the spherical recess. In this structure, it is desirable that the seal member in the spherical protrusion and the seal member in the spherical recess be located at positions that would not interfere with each other. The seal member can be placed on the top-end side of the spherical protrusion and the spherical recess (a position closer to the accepter-side joint member if the spherical protrusion or the spherical recess is formed in the reservoir-side joint member; or a position closer to the reservoir-side joint member if the spherical protrusion or the spherical recess is formed in the accepter-side joint member).

The liquid send/receive joint device according to the invention maybe configured so that at least one of the spherical protrusion and the spherical recess is made of an elastic member, and the elasticity of the elastic member keeps an area between the spherical protrusion and the spherical recess watertight. In addition to the advantageous effects described above, the above-described configuration prevents liquid leakage with more certainty.

Furthermore, the liquid send/receive joint device according to the invention can be configured so that the reservoir-side joint member further includes a reservoir-side supply passage for supplying the liquid to the accepter-side joint member, and a reservoir-side valve element for opening and closing the reservoir-side supply passage, and the accepter-side joint member further includes an accepter-side supply passage that is connected to the reservoir-side supply passage so as to allow the liquid to flow therebetween and supplies the liquid from the reservoir-side supply passage to the liquid accepter, and an accepter-side valve element for opening and closing the accepter-side supply passage; wherein the reservoir-side valve element opens after the accepter-side valve element opens. When the liquid is supplied from the liquid reservoir to the liquid accepter, the above-described configuration causes the liquid to be supplied from the liquid reservoir after the liquid accepter becomes capable of receiving the liquid. Accordingly, in addition to the aforementioned advantageous effects, it is possible to supply the liquid more smoothly and prevent liquid leakage with more certainty.

The accepter-side valve element can be configured so that it closes after the reservoir-side valve element closes. This configuration makes the liquid accepter stop receiving the liquid after the liquid supply from the liquid reservoir has been stopped. Accordingly, in addition to the aforementioned advantageous effects, it is possible to prevent liquid leakage with more certainty when the liquid supply is stopped.

Furthermore, in the liquid send/receive joint device according to the invention, the reservoir-side joint member has a reservoir-side container that contains the reservoir-side valve element in such a manner that the reservoir-side valve element can move, and in which the reservoir-side supply passage is formed; and the accepter-side joint member has an accepter-side container that contains the accepter-side valve element in such a manner that the accepter-side valve element can move, and in which the accepter-side supply passage is formed. The liquid send/receive joint device can be configured so that when the reservoir-side joint member and the accepter-side joint member are connected to each other, the end face of the reservoir-side container comes into contact with the end face of the accepter-side container and this contact force makes the reservoir-side valve element and the accepter-side valve element open or close.

In the above configuration, at least one of the reservoir-side container and the accepter-side container may be made of an elastic member and its end face may be formed into a spherical protrusion or a spherical recess. Consequently, when the end face of the reservoir-side container comes into contact with the end face of the accepter-side container so that the reservoir-side supply passage is connected to the accepter-side supply passage so as to allow the liquid to flow between them, it is possible to have the end face of the reservoir-side container and the end face of the accepter-side container closely in contact with each other with more certainty, keep an area between the end faces watertight, and prevent liquid leakage more reliably.

The reservoir-side joint member can further include a force-applying member for applying force to the reservoir-side valve element so that the reservoir-side valve element is moved according to the force applied by the force-applying member. Also, the accepter-side joint member can further include a force-applying member for applying force to the accepter-side valve element so that the accepter-side valve element is moved according to the force applied by the force-applying member. Moreover, the applied force can be controlled by elasticity of the elastic member. In this case, the applied force is controlled by, for example, rubber hardness.

According to another aspect of the invention, a fuel cell system including: a fuel cell; a liquid reservoir containing liquid fuel; a liquid accepter for receiving the liquid fuel from the liquid reservoir and supplying it to the fuel cell; and the aforementioned liquid send/receive joint device according to the invention is provided.

Since the fuel cell system having the above-described configuration can always maintain a good connection between the liquid reservoir and the liquid accepter, the liquid fuel can be supplied easily and safely. Incidentally, the liquid fuel can include methanol.

In the liquid send/receive joint device according to the invention, the reservoir-side joint member and the accepter-side joint member are connected to each other via the spherical joint mechanism. Accordingly, when the liquid reservoir and the liquid accepter are connected to each other, the spherical joint mechanism can allow for displacement in the positional relationship between the liquid reservoir and the liquid accepter. As a result, it is possible to maintain a good connection between the liquid reservoir and the liquid accepter and send/receive the liquid safely and with certainty.

Since the fuel cell system according to the invention is equipped with the liquid send/receive joint device according to the invention, it is possible to always maintain a good connection between the liquid reservoir and the liquid accepter. As a result, the liquid fuel can be supplied safely and with certainty.

### BRIEF DESCRIPTION OF THE DRAWINGS

FIG. 1 is a cross-sectional view of a reservoir-side joint member and an accepter-side joint member—components of a liquid send/receive joint device according to an embodiment of the invention—before they are connected to each other.

FIG. 2 is a cross-sectional view of the reservoir-side joint member and the accepter-side joint member in FIG. 1 when they are connected to each other.

FIG. 3 is a cross-sectional view of the reservoir-side joint member and the accepter-side joint member in FIG. 2 in the state where the accepter-side joint member is inclined relative to the reservoir-side joint member.

FIG. 4 is a perspective cross-sectional view of the reservoir-side joint member and the accepter-side joint member according to the embodiment, and shows a stage of the process from the pre-connection state to the state where they are connected to each other to supply liquid through them.

FIG. 5 is a perspective cross-sectional view of the reservoir-side joint member and the accepter-side joint member according to the embodiment, and shows a stage of the process from the pre-connection state to the state where they are connected to each other to supply liquid through them.

FIG. 6 is a perspective cross-sectional view of the reservoir-side joint member and the accepter-side joint member according to the embodiment, and shows a stage of the process from the pre-connection state to the state where they are connected to each other to supply liquid through them.

FIG. 7 is a perspective cross-sectional view of the reservoir-side joint member and the accepter-side joint member according to the embodiment, and shows a stage of the process from the pre-connection state to the state where they are connected to each other to supply liquid through them.

FIG. 8 is a perspective cross-sectional view of the reservoir-side joint member and the accepter-side joint member according to the embodiment, and shows a stage of the process from the pre-connection state to the state where they are connected to each other to supply liquid through them.

FIG. 9 is a perspective cross-sectional view of the reservoir-side joint member and the accepter-side joint member according to the embodiment, and shows a stage of the process from the pre-connection state to the state where they are connected to each other to supply liquid through them.

FIG. 10 is a schematic diagram showing the state where the reservoir-side joint member is placed at a liquid reservoir, and the accepter-side joint member is placed at the liquid accepter according to the embodiment.

FIG. 11 is a schematic diagram showing the state where the reservoir-side joint member and the accepter-side joint member in FIG. 10 are connected to each other.

FIG. 12 is a schematic diagram of a fuel cell system equipped with the liquid send/receive joint device according to an embodiment of the invention.

FIG. 13 is a plane view of the reservoir-side joint member according to another embodiment of the invention.

FIG. 14 is a plane view of the accepter-side joint member according to another embodiment of the invention.

### DETAILED DESCRIPTION OF PREFERRED EMBODIMENTS

A liquid send/receive joint device according to preferred embodiments of the invention, and a fuel cell system equipped with this liquid send/receive joint device will be described below with reference to the attached drawings. The embodiments described below are for the purpose of describing this invention, but the invention is not limited only to those embodiments. Accordingly, this invention can be utilized in various ways unless those utilizations depart from the gist of the invention.

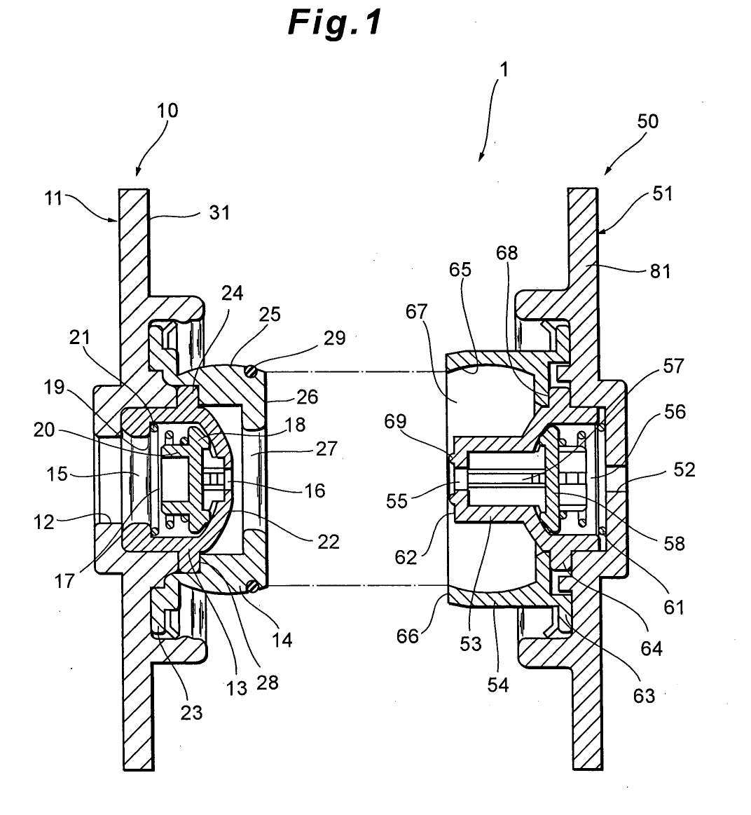

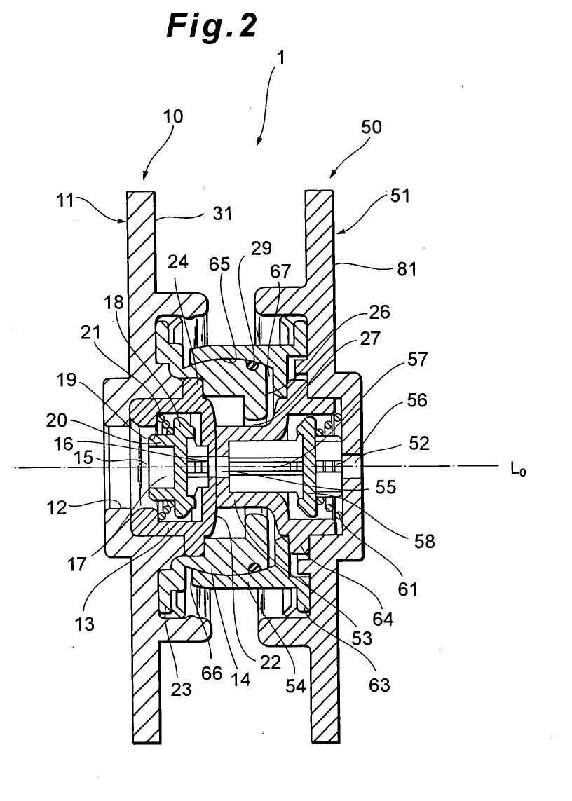

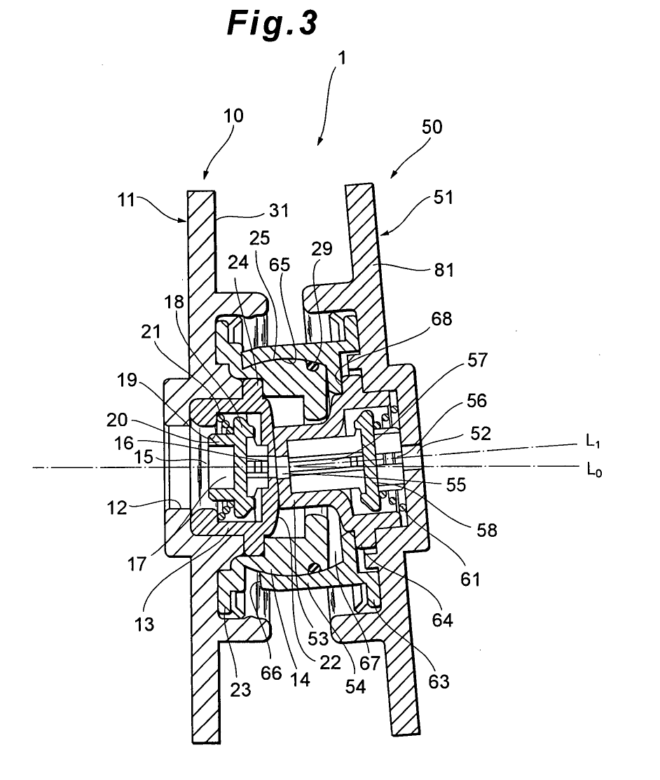

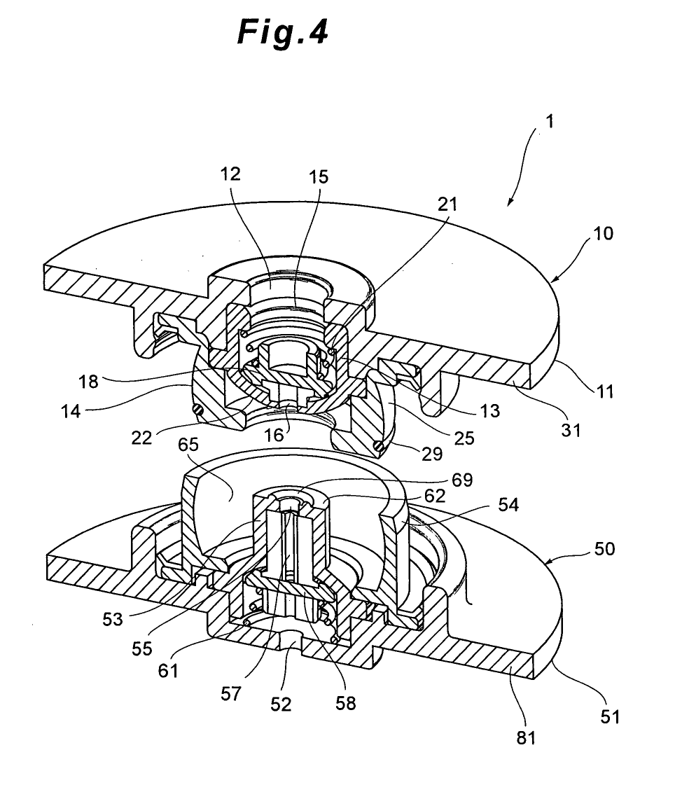

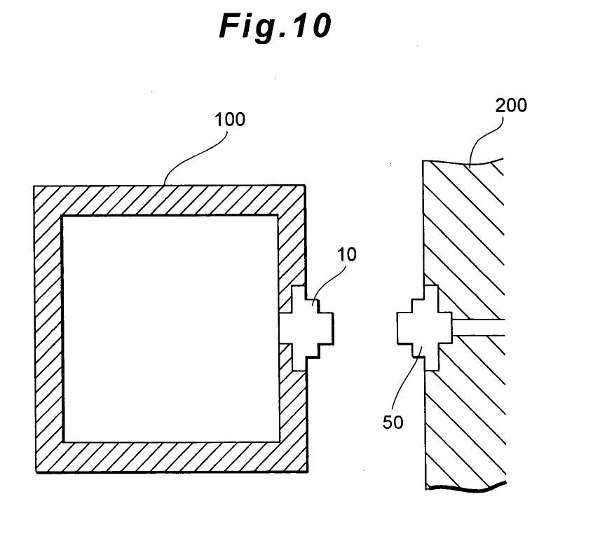

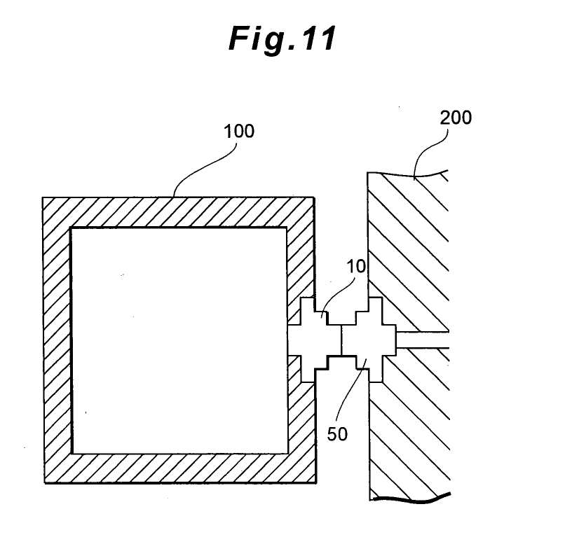

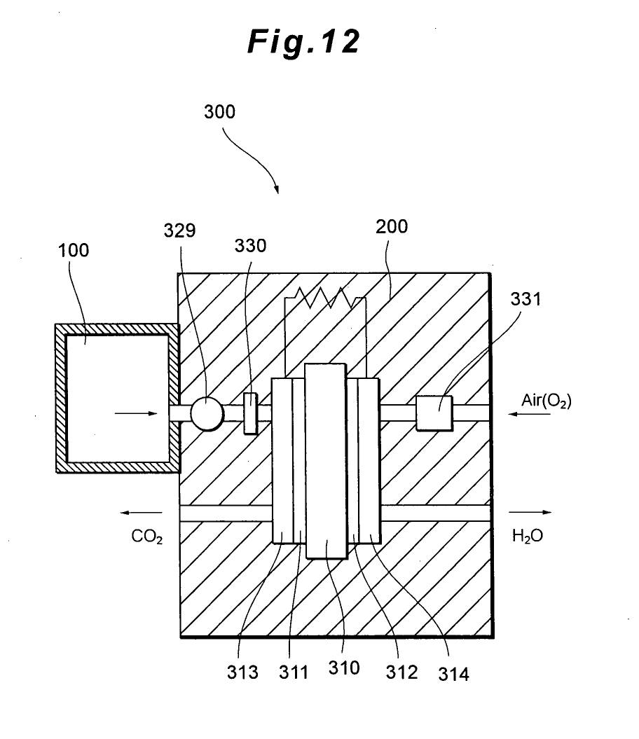

FIG. 1 is a cross-sectional view of a reservoir-side joint member and an accepter-side joint member—the components of a liquid send/receive joint device according to an embodiment of the invention—before they are connected to each other. FIG. 2 is a cross-sectional view of the reservoir-side joint member and the accepter-side joint member in FIG. 1 when they are connected to each other. FIG. 3 is a cross-sectional view of the reservoir-side joint member and the accepter-side joint member in FIG. 2 in the state where the accepter-side joint member is inclined relative to the reservoir-side joint member. FIGS. 4 to 9 are perspective cross-sectional views of the reservoir-side joint member and the accepter-side joint member according to an embodiment of the invention and show stages of the process from the pre-connection state to the state where they are connected to each other to supply the liquid through them. FIG. 10 is a schematic diagram showing the state where the reservoir-side joint member is attached to a liquid reservoir, and the accepter-side joint member is attached to the liquid accepter according to the embodiment. FIG. 11 is a schematic diagram showing the state where the reservoir-side joint member and the accepter-side joint member in FIG. 10 are connected to each other. FIG. 12 is a schematic diagram of a fuel cell system equipped with the liquid send/receive joint device according to the embodiment of the invention.

As shown in FIGS. 1 to 12, a liquid send/receive joint device 1 according to an embodiment of the invention includes: a reservoir-side joint member 10 that can be attached to a liquid reservoir 100 (see FIGS. 10 to 12); and an accepter-side joint member 50 that can be attached to a liquid accepter 200 (see FIGS. 10 to 12) and connected to the reservoir-side joint member 10 in such a manner that the accepter-side joint member 50 can be attached to or detached from the reservoir-side joint member 10 whenever necessary.

The reservoir-side joint member 10 includes: a base 11 to be mounted on the liquid reservoir 100; a reservoir-side container 13 that is fixed to the base 11 and supplies the liquid from the liquid reservoir 100 to the accepter-side joint member 50; and a joint part 14 that is fixed to the base 11 and the reservoir-side container 13 and connects the reservoir-side joint member 10 to the accepter-side joint member 50.

A through-hole 12 for allowing the liquid supplied from the liquid reservoir 100 to pass through is formed in a substantially central part of the base 11. Also, a flange 31 for attaching the base 11 to a housing for the liquid reservoir 100 is formed on the outside surface of the base 11. The base 11 is attached to the housing for the liquid reservoir 100 (by an arbitrary method) so as to prevent liquid leakage from the area where the base 11 is attached to the housing for the liquid reservoir 100. Incidentally, the base 11 and the housing for the liquid reservoir 100 may be integrally molded by means of, for example, insert molding or two-color molding in order to prevent liquid leakage from the area where the base 11 is attached to the housing for the liquid reservoir 100.

The reservoir-side container 13 is made of an elastic member (a material capable of elastically changing its shape) and has a supply port 15 for supplying the liquid from the liquid reservoir 100 to the reservoir-side container 13 and a discharge port 16 for discharging the liquid contained in the reservoir-side container 13 toward the liquid accepter 200. Also, there is a reservoir-side supply passage 17 that connects the supply port 15 to the discharge port 16 so as to supply the liquid from the liquid reservoir 100 to the accepter-side joint member 50.

A flange 24 to be held between the base 11 and the joint part 14 described later in detail is formed on the outside surface of the reservoir-side container 13. An end face 22 of the reservoir-side container 13 on the side where the discharge port 16 is formed constitutes a convex surface. When an end face 62 of the accepter-side container 53 described later in detail on the side where the supply port 55 is formed comes into contact with and presses the end face 22, the end face 22 elastically changes its shape and becomes almost flat (see FIG. 2); when the pressure is released, the end face 22 can elastically return to its original shape.

Inside the reservoir-side container 13, a reservoir-side valve element 18 for opening or closing the reservoir-side supply passage 17 is provided in such a manner that the reservoir-side valve element 18 can move. A valve sheet 19 for fastening one end of a spring 21 described later in detail is formed on the inside surface of the reservoir-side container 13 on the supply port 15 side. A protrusion 20 that is hollow and of a cylindrical shape is also formed on the supply port 15 side of the reservoir-side valve element 18, and the other end of the spring 21 is fastened to this protrusion 20. This spring 21 is provided between the valve sheet 19 and the protrusion 20 and always applies force to the reservoir-side valve element 18 toward the discharge port 16 side. This applied force brings the reservoir-side valve element 18 into contact with the inside wall of the reservoir-side container 13 and closes the reservoir-side supply passage 17 (i.e., closes the reservoir-side valve element 18).

As the material for the reservoir-side container 13, various known elastic materials such as rubbers and elastomers can be used. Specific examples of the elastic materials include: styrene butadiene rubber, butadiene rubber, syndiotactic 1,2-polybutadiene, isoprene rubber, acrylonitrile-butadiene rubber, chloroprene rubber, ethylene-propylene rubber, ethylene-propylene terpolymer, butyl rubber, acrylic rubber, chlorosulfonated polyethylene, silicon rubber, vinylidene fluoride rubber, tetrafluoroethylene-propylene rubber, tetrafluoroethylene perfluoromethyl vinyl ether rubber (flubrosilicon rubber, epichlorohydrin rubber, polysulfide rubber, urethane rubber, and natural rubber. The rubber types can be used alone, or in combination.

The material for the reservoir-side container 13 is ideally selected according to the properties of the liquid to be sent or received, and according to the properties of the elastic member such as slide, permanent compressive strain, rebound resilience, and elution resistance. If the liquid reservoir is a methanol fuel cartridge used in a DMFC and a 3 wt % methanol solution is to be sealed in the liquid reservoir, ethylene-propylene rubber, which has excellent methanol resistance and permanent compressive strain, can be used. In this case, the liquid accepter can contain a DMFC main body (product number 6061; manufactured by Eifrig Inc.).

The joint part 14 can be made of an elastic material, and the outside surface of the joint part 14 is of a generally cylindrical shape that forms a spherical protrusion surface 25, and the joint part 14 is hollow inside. In this hollow area, part of the reservoir-side container 13 is placed. This joint part 14 engages in a snap-fit manner with a joint part 54 of the accepter-side joint member 50 described later in detail. A flange 23 for fastening the joint part 14 to the base 11 is formed on the base 11 side of the joint part 14. Also, at an end face 26 of the joint part 14 opposite the flange 23, an opening 27 through which the end of the accepter-side container 53 on the side where the supply port 55 is formed can be inserted or removed is made.

The joint part 14 is equipped with a safety mechanism that prevents liquid leakage due to false contact with the accepter-side joint member 50, except they are in contact with each other because they are connected (or joined). This safety mechanism is composed by forming the end face 26 of the joint part 14 into a shape that bends inwardly (toward the reservoir-side container 13). Specifically speaking, the distance (or depth) between this end face 26 and the end face 22 of the reservoir-side container 13 or the thickness of the end face 26 is set to sufficiently larger than the size of the opening 27 (opening area). Accordingly, if somebody like a young child touches or holds by mistake the liquid reservoir 100, on which the reservoir-side joint member 10 is mounted, and presses his fingers onto the reservoir-side joint member 10, it is possible to prevent any contact with the reservoir-side container 13, avoid accidental liquid leakage, and ensure sufficient safety. A sufficient depth in this case would depend on the shape and size of the liquid reservoir 100, and accordingly the shape and size of the reservoir-side joint member 10. However, generally, it is desirable that the relationship described below be established with regard to the sufficient depth.

The following relationship should preferably be established where the open area of the opening 27 is “S” and the length from the end face 26 to the reservoir-side container 13 is “d”:

(d/S)≧4×10⁻³

A stepped part 28 for engaging with the flange 24 formed on the reservoir-side container 13 is formed on the inside wall of the joint part 14. Also, a seal member 29 is provided near the opening 27 in the spherical protrusion surface 25. Specifically speaking, the seal member 29 is placed at a position (offset position) slightly off-center on the spherical protrusion surface 25.

Incidentally, the aforementioned materials for the reservoir-side container 13 can be used as the material for the joint part 14.

The accepter-side joint member 50 includes: a base 51 to be mounted on the liquid accepter 200; an accepter-side container 53 that is fixed to the base 51 and supplies the liquid from the liquid reservoir 100 via the reservoir-side joint member 10; and a joint part 54 that is fixed to the base 51 and the accepter-side container 53 and connects the accepter-side joint member 50 to the reservoir-side joint member 10.

A through-hole 52 for supplying the liquid to the liquid accepter 200 is formed in a substantially central part of the base 51. Also, a flange 81 for attaching the base 51 to a housing for the liquid accepter 200 is formed on the outside surface of the base 51. The base 51 is attached to the housing for the liquid accepter 200 by an arbitrary method so as to prevent liquid leakage from the area where the base 51 is attached to the housing for the liquid accepter 200. Incidentally, the base 51 and the housing for the liquid accepter 200 may be integrally molded by means of, for example, insert molding or two-color molding in order to prevent liquid leakage from the area where the base 51 is attached to the housing for the liquid accepter 200.

The accepter-side container 53 is made of an elastic member (a material capable of elastically changing its shape) and has a supply port 55 for supplying the liquid from the liquid reservoir 100 via the reservoir-side joint member 10 to the accepter-side container 53, and a discharge port 56 for discharging the liquid contained in the accepter-side container 53 toward the liquid accepter 200. Also, there is an accepter-side supply passage 57 that connects the supply port 55 to the discharge port 56 so as to supply the liquid from the liquid reservoir 100 to the liquid accepter 200.

A flange 64 to be held between the base 51 and the joint part 54 described later in detail is formed on the outside surface of the accepter-side container 53. An end face 62 of the accepter-side container 53 on the side where the supply port 55 is formed constitutes a flat surface. When the end face 22 of the reservoir-side container 13 comes into contact with the end face 62, pressure applied by the end face 62 elastically changes the shape of the end face 22 and makes it almost flat. When this happens, this elastic shape change brings the end faces 62 and 22 into close contact with each other and an area between the discharge port 16 and the supply port 55 can be kept watertight. Moreover, since a labyrinth seal 69 is formed near the periphery of the supply port 55 of the end face 62, the area between the discharge port 16 and the supply port 55 can be kept more watertight. Incidentally, when the pressure is released, the elastic end face 22 of the reservoir-side container 13 returns to its original shape.

Inside the reservoir-side container 53, an accepter-side valve element 58 for opening or closing the accepter-side supply passage 57 is provided in such a manner that the accepter-side valve element 58 can move. One end of a spring 61 described later in detail is fastened to an end of the inside wall of the accepter-side container 13 on the discharge port 56 side. The other end of the spring 61 is fastened to an end of the accepter-side valve element 58 on the discharge port 56 side. This spring 61 is provided between the accepter-side valve element 58 and the base 51 and always applies force to the accepter-side valve element 58 toward the supply port 55 side. This applied force brings the accepter-side valve element 58 into contact with the accepter-side container 53 and closes the accepter-side supply passage 57 (i.e., closes the accepter-side valve element 58).

In this embodiment, a spring that applies weaker force (spring force) than that of the spring 21 that applies force to the reservoir-side valve element 18 is used as the spring 61 to apply force to the accepter-side valve element 58. Accordingly, the accepter-side container 53 has a larger deformation volume than that of the reservoir-side container 13 when the same force is applied. When the end face 22 of the reservoir-side container 13 comes into contact with the end face 62 of the accepter-side container 53 and pressure is generated between them, the accepter-side valve element 58 first opens the accepter-side supply passage 57 against the force applied by the spring 61 (i.e., causing the accepter-side valve element 58 to open), and then the reservoir-side valve element 18 opens the reservoir-side supply passage 17 against the force applied by the spring 21 (i.e., causing the reservoir-side valve element 18 to open). Therefore, when supplying the liquid from the liquid reservoir 100 to the liquid accepter 200, the liquid is supplied from the liquid reservoir 100 after the liquid accepter 200 becomes capable of receiving the liquid. As a result, it is possible to supply the liquid smoothly and prevent liquid leakage with more certainly.

Furthermore, when stopping the supply of the liquid from the liquid reservoir 100 to the liquid accepter 200, it is only necessary to release the contact between the end face 22 of the reservoir-side container 13 and the end face 62 of the accepter-side container 53. In doing so, the force applied by the spring 18 causes the reservoir-side valve element 18 to move and thereby close the reservoir-side supply passage 17 (i.e., causing the reservoir-side valve element 18 to close), and then the force applied by the spring 61 causes the accepter-side valve element 58 to move and thereby close the accepter-side supply passage 57 (i.e., causing the accepter-side valve element 58 to close). As a result, the liquid accepter 200 stops receiving the liquid only after the liquid supply from the liquid reservoir 100 is stopped, and when the liquid supply is stopped, it is possible to prevent liquid leakage with more certainty.

The joint part 54 can be made of an elastic material and is hollow inside, and the inside surface of the joint part 54 is of a generally cylindrical shape that forms a spherical recess surface 65. In the hollow area, part of the accepter-side container 53 is placed. The joint part 54 engages in a snap-fit manner with the joint part 14 of the reservoir-side joint member 10. A flange 63 for fastening the joint part 54 to the base 51 is formed on the base 51 side of the joint part 54. A stepped part 68 for engaging with the flange 64 on the accepter-side container 53 is formed on the inside wall of the joint part 54. Also, at an end face 66 of the joint part 54 opposite the flange 63, an opening 67 through which the joint part 14 can be inserted or removed is made. By inserting the joint part 14 into this opening 67, the spherical protrusion surface 25 formed on the outside surface of the joint part 14 and the spherical recess surface 65 formed on the inside surface of the joint part 54 constitute the spherical joint mechanism, and the reservoir-side joint member 10 and the accepter-side joint member 50 are connected to each other via this spherical joint mechanism.

When the liquid reservoir 100 and the liquid accepter 200 are connected to each other via the liquid send/receive joint device 1, the direction in which the reservoir-side joint member 10 and the accepter-side joint member 50 are connected is located on a straight line L₀ shown in FIG. 2. If the liquid send/receive joint device 1 in the above-described state becomes subject to external force applied in a direction generally perpendicular to the direction in which the liquid reservoir 100 and the liquid accepter 200 are connected, the connection direction of the accepter-side joint member 50 is then located on a straight line L₁ in FIG. 3 relative to the connection direction of the reservoir-side joint member 10, which means that the positional relationship between them has changed (or been displaced). Even in this case, the reservoir-side joint member 10 and the accepter-side joint member 50 are connected to each other via the aforementioned spherical joint mechanism. Accordingly, this spherical joint mechanism allows for the change in the positions of the reservoir-side joint member 10 and the accepter-side joint member 50. As a result, a good connection between the liquid reservoir 100 and the liquid accepter 200 can be always maintained. In this situation as shown in FIG. 3, the end face 22 of the reservoir-side container 13, because of its elasticity, absorbs the inclination of the end face 62 of the accepter-side container 53, and the end faces 22 and 62 can be kept in close contact with each other.

The aforementioned materials able to be used for the reservoir-side container 13 can be used as the material for the accepter-side container 53 and the joint part 54.

Next, specific actions of the liquid send/receive joint device 1 according to this embodiment will be described below with reference to the relevant drawings.

When connecting the liquid reservoir 100 with the liquid accepter 200 via the liquid send/receive joint device 1, the reservoir-side joint member 10 is attached to the housing for the liquid reservoir 100 by fixing the base 11 of the reservoir-side joint member 10 to the housing for the liquid reservoir 100 as schematically shown in FIG. 10. Similarly, the accepter-side joint member 50 is attached to the housing for the liquid accepter 200 by fixing the base 51 of the accepter-side joint member 50 to the housing for the liquid accepter 200. Subsequently, as shown in FIG. 4 (the liquid reservoir 100 and the liquid accepter 200 are omitted) and FIG. 10, the reservoir-side joint member 10 mounted on the liquid reservoir 100 and the accepter-side joint member 50 mounted on the liquid accepter 200 are placed opposite each other.

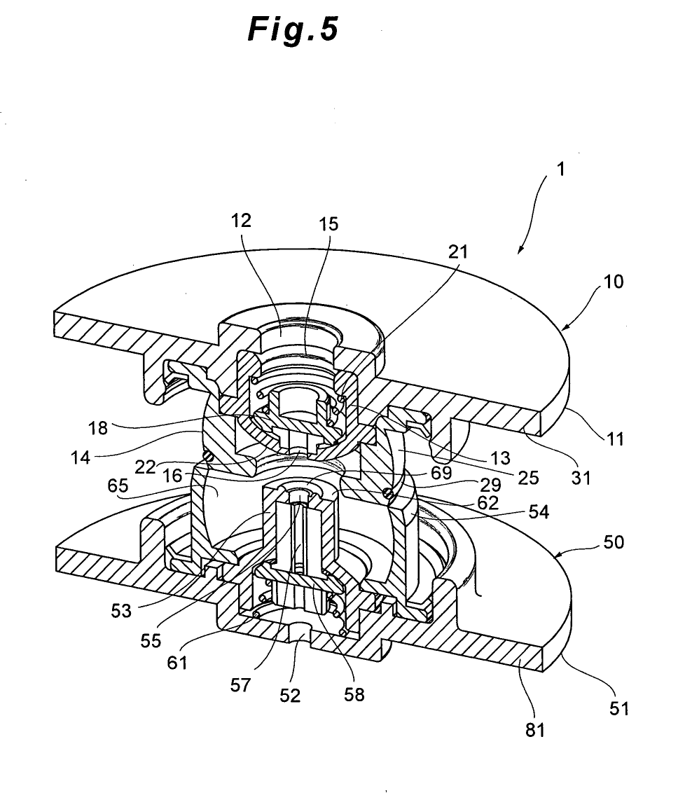

Next, as shown in FIG. 5 (the liquid reservoir 100 and the liquid accepter 200 are omitted), the joint part 14 of the reservoir-side joint member 10 is moved closer to the opening 67 made in the joint part 54 of the accepter-side joint member 50 so that the joint part 14 can be inserted into the opening 67.

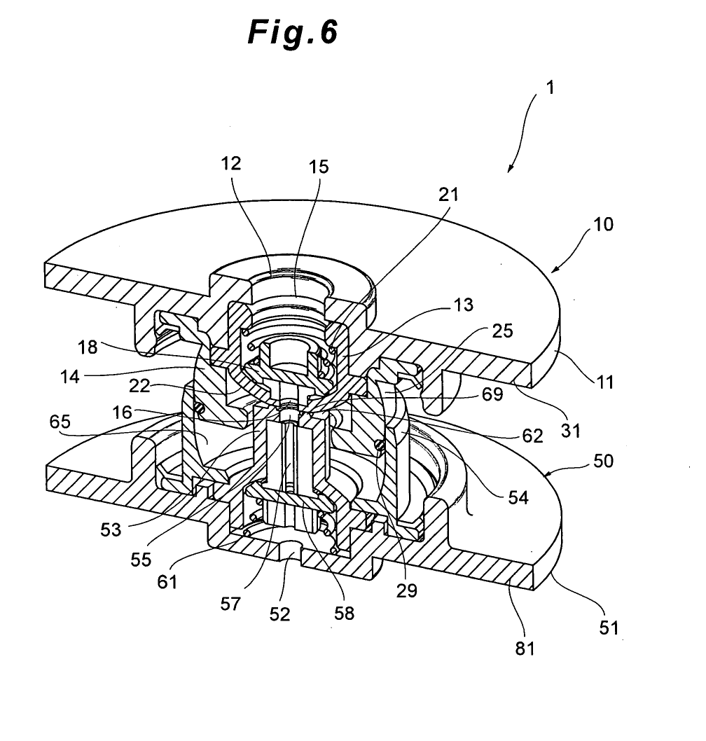

Then as shown in FIG. 6 (the liquid reservoir 100 and the liquid accepter 200 are omitted), the joint part 14 is inserted into the joint part 54 by having the spherical protrusion surface 25, which is the outside surface of the joint part 14, in contact with the spherical recess surface 65, which is the inside surface of the joint part 54. This action brings the end face 22 of the reservoir-side container 13 into contact with the end face 62 of the accepter-side container 53. In this state, the reservoir-side valve element 18 and the accepter-side valve element 58 are each closed, and the liquid supply from the liquid reservoir 100 to the liquid accepter 200 is blocked.

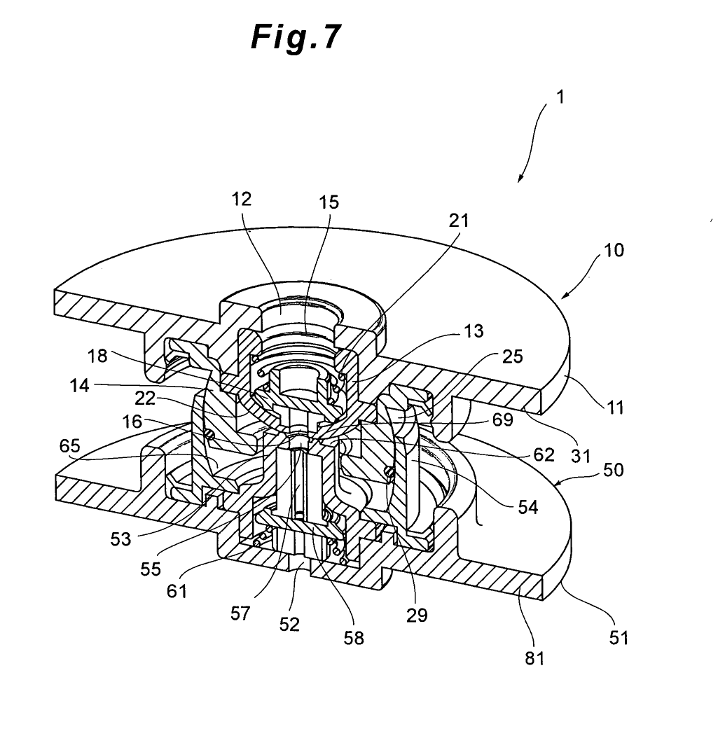

After the end face 22 of the reservoir-side container 13 comes into contact with the end face 62 of the accepter-side container 53, the joint part 14 is further inserted deep into the joint part 54. Then, pressure generated between the reservoir-side container 13 and the accepter-side container 53 opens the accepter-side valve element 58, as shown in FIG. 7, against the force applied by the spring 61, thereby opening the accepter-side supply passage 57. This action makes the liquid accepter 200 capable of receiving the liquid via the accepter-side joint member 50.

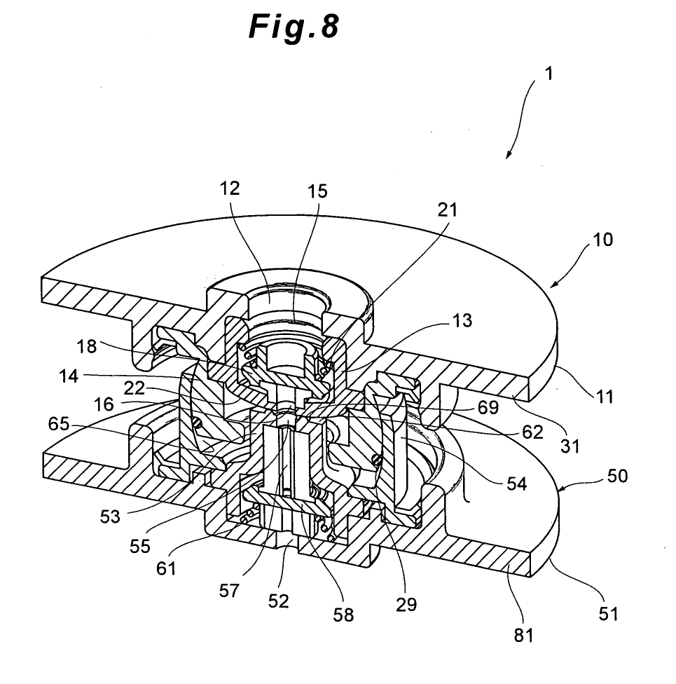

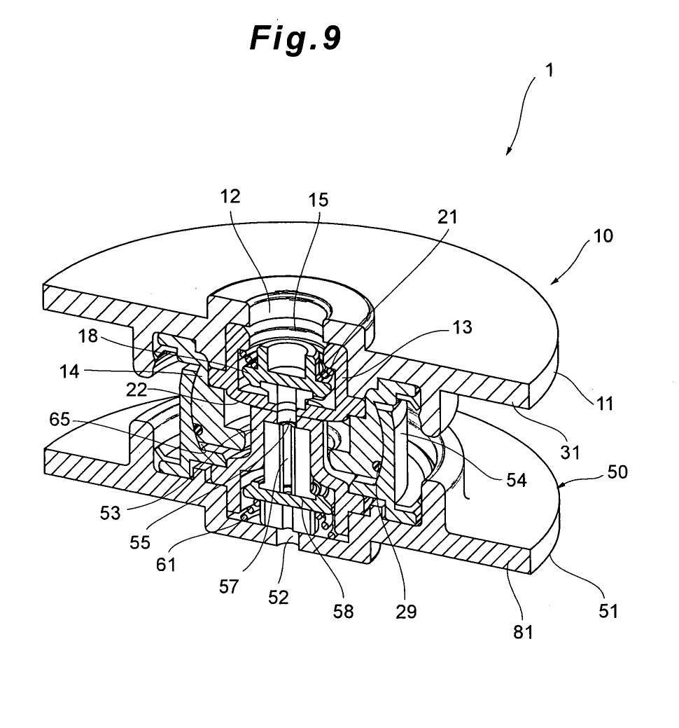

Subsequently, if the joint part 14 is further inserted deep into the joint part 54, the reservoir-side valve element 18 opens, as shown in FIG. 8, against the force applied by the spring 21, thereby opening the reservoir-side supply passage 17. As a result of this action, the accepter-side supply passage 57, which has been already opened, is connected with the reservoir supply as shown in FIG. 9 so as to allow the liquid to flow through them. Since the joint part 14 and the joint part 54 are made of elastic materials, the joint part 14 engages with the joint part 54 in a snap-fit manner (like snap hooks [or snap-fit units]).

When this happens, the end face 22 of the reservoir-side container 13 changes its shape, because of its elasticity, from a convex surface into an almost flat surface and thereby comes into close contact with the end face 62 of the accepter-side container 53. Also, the labyrinth seal 69 provided on the end face 62 keeps the discharge port 16 of the reservoir-side container 13 and the supply port 55 of the accepter-side container 53 watertight. Furthermore, the seal member 29 provided on the spherical protrusion surface 25 of the joint part 14 keeps an area between the spherical protrusion surface 25 and the spherical recess surface 65 watertight. Since the reservoir-side joint member 10 and the accepter-side joint member 50 are connected to each other via the spherical joint mechanism as described above, even if the connection positions of the liquid reservoir 100 and the liquid accepter 200 change (or are displaced) from their original positions, a good connection between them can be maintained.

On the other hand, in order to stop supplying the liquid from the liquid reservoir 100, it is only necessary to disconnect the reservoir-side joint member 10 from the accepter-side joint member 50. When the reservoir-side joint member 10 is disconnected from the accepter-side joint member 50, the force applied by the spring 18 closes the reservoir-side valve element 18, thereby closing the reservoir-side supply passage 17. Then, the force applied by the spring 61 closes the accepter-side valve element 58, thereby closing the accepter-side supply passage 57. Consequently, the liquid accepter 200 stops receiving the liquid after the liquid supply from the liquid reservoir 100 is stopped, and it is possible to prevent liquid leakage with more certainty when the liquid supply is stopped.

The liquid send/receive joint device 1 according to this embodiment can be used in a fuel cell system 300 shown in FIG. 12. This fuel cell system 300 employs a methanol fuel cell (DMFC) as a fuel cell serving as the liquid accepter 200. The fuel cell system 300 includes: an electrolyte membrane 310 made of, for example, perfluoro sulfonate polymer; an anode electrode 311 provided on one side of the electrolyte membrane 310; a cathode electrode 312 provided on the other side of the electrolyte membrane 310; and a pair of separators 314 provided to hold both the electrodes 311 and 312 between them.

In this fuel cell system 300, fuel (methanol) supplied from a fuel cartridge, which is the liquid reservoir 100, to the fuel cell, which is the liquid accepter 200, passes through a pump 329 and a filter 330, and is then supplied to the anode electrode 311. On the other hand, oxygen is supplied to the cathode electrode 312 by sending air from the atmosphere to the cathode electrode 312. In this case, it is desirable that an air blower mechanism 331 composed of, for example, fans be provided somewhere in a passage to send the air to the cathode electrode 312. Accordingly, it is possible to increase the oxygen supply amount as necessary. Methanol and oxygen supplied in this manner generate electric power by means of a chemical reaction. After the chemical reaction, the methanol and oxygen are discharged as water or CO₂ from the fuel cell system 300.

This embodiment described the case where the seal member 29 is provided on the spherical protrusion surface 25 formed on the joint part 14 of the reservoir-side joint member 10, and the seal member 29 further ensures watertightness of an area between the spherical protrusion surface 25 and the spherical recess surface 65 formed in the joint part 54 of the accepter-side joint member 50. However, the configuration of the invention is not limited to this example, and at least one of the spherical protrusion surface 25 and the spherical recess surface 65 may be made of an elastic member so that the elasticity of this elastic member brings the spherical protrusion surface 25 and the spherical recess surface 65 into close contact with each other and keeps the area between them watertight.

Also, this embodiment described the case where the seal member 29 is located at a position (offset position) slightly off-center on the spherical protrusion surface 25. However, the position of the seal member 29 is not limited to this example, and the seal member 29 may be placed at any desirable position on the spherical protrusion surface 25 or at any desirable position on the spherical recess surface 65.

Furthermore, this embodiment described the case where the end face 22 of the reservoir-side container 13 is composed of a convex surface and the end face 62 of the accepter-side container 53 is composed of an almost flat surface. However, the shapes of the end faces 22 and 62 are not limited to this example, and the end face 22 may be composed of an almost flat surface and the end face 62 may be composed of a convex surface, or both the end faces 22 and 62 may be composed of convex surfaces, or both may be composed of almost flat surfaces. Therefore, there is no particular limitation on the shapes of the end faces 22 and 62, as long as the discharge port 16 formed in the end face 22 and the supply port 55 formed in the end face 62 can be kept watertight. Furthermore, the discharge port 16 and the supply port 55 may be kept watertight by providing, for example, a seal member; however, the seal member or similar may not be provided if the end faces 22 and 62 can keep the discharge port 16 and the supply port 55 watertight.

Also, the embodiment described the case where the joint part 14 is made of the elastic member. However, the material for the joint part 14 is not limited to the elastic member, and the joint part 14 may be made of, for example, plastic, metals, or ceramics.

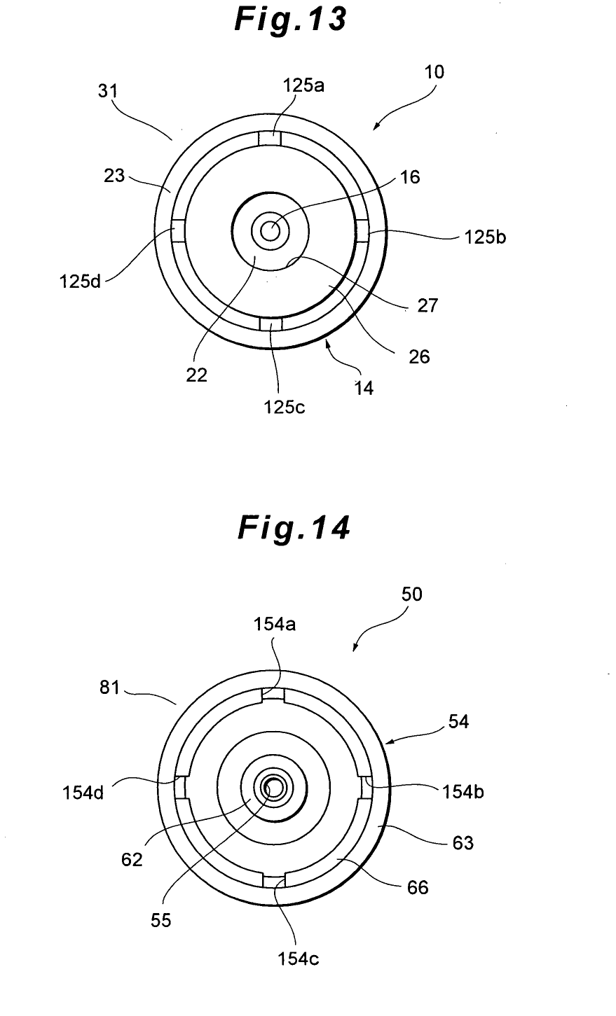

A mechanical key mechanism may be provided on the reservoir-side joint member 10 and the accepter-side joint member 50 in order to prevent a liquid reservoir 100 and liquid accepter 200 of different standards or sizes from being connected. Specifically speaking, as shown in FIGS. 13 and 14, four protrusions 125a to 125d can be placed at respective positions which are apart by 90 degrees around the spherical protrusion surface 25 of the joint part 14 of the reservoir-side joint member 10 (see FIG. 13), and four recesses 154a to 154d composed of notches of a size and shape that allow the protrusions 125a to 125d to fit inside, can be formed at respective positions which are apart by 90 degrees around the joint part 54 of the accepter-side joint member 50 (see FIG. 14). If there are different standards, sizes, and specifications for the liquid reservoir 100 and the liquid accepter 200 to be connected, faulty connection of a liquid reservoir 100 and liquid accepter 200 of different standards or sizes can be effectively prevented by changing, for example, the structure of the mechanical key mechanism (such as the protrusions 125a to 125d and the recesses 154a to 154d) according to the differences in, for example, the standards, sizes, or specifications.

Specific examples of changing the structure of the mechanical key mechanism include changing, for example, the shape or size of the protrusions 125a to 125d and the recesses 154a to 154d, or the number of the protrusions 125a to 125d and the recesses 154a to 154d. Incidentally, it should be understood that recesses may be formed in the joint part 14 and protrusions may be formed on the joint part 54.

This embodiment described the case where the liquid send/receive joint device 1 is utilized in the fuel cell system 300. However, utilization of the liquid send/receive joint device 1 is not limited to this example, and the liquid send/receive joint device 1 can be utilized in various liquid send/receive apparatuses. For example, various apparatuses such as ink cartridges containing ink or chemical containers can be used as the liquid reservoir 100, while various apparatuses such as printers that receive ink from ink cartridges, or apparatuses to which chemicals are fed from the chemical containers can be used as the liquid accepter 200. In this case, the liquid send/receive joint device 1 is considered more effective as a joint device particularly for a small-sized liquid send/receive apparatus with a low flow rate of the liquid to be supplied.

The shapes of the liquid reservoir 100 and the liquid accepter 200 are not limited to the aforementioned examples, and various shapes can be utilized. Furthermore, the shapes of the reservoir-side joint member 10 and the accepter-side joint member 50 are not limited to cylindrical shapes (or circular shapes in their cross-sections). If the reservoir-side joint member 10 and the accepter-side joint member 50 are of rectangular shapes, the shapes of the reservoir-side joint member 10 and the accepter-side joint member 50 themselves can serve as the mechanical key function, that is, the function that prevents a liquid reservoir 100 and liquid accepter 200 of different standards or sizes from being connected.

What is claimed is:

1. A liquid send/receive joint device for connecting a liquid reservoir containing a liquid to a liquid accepter for receiving the liquid from the liquid reservoir, the liquid send/receive joint device comprising:
a reservoir-side joint member that can be attached to the liquid reservoir; and
an accepter-side joint member that can be attached to the liquid accepter and connected to the reservoir-side joint member in such a manner that the accepter-side joint member can be attached to or detached from the reservoir-side joint member whenever necessary;
wherein the reservoir-side joint member and the accepter-side joint member are connected to each other via a spherical joint mechanism.

2. The liquid send/receive joint device according to claim 1, wherein the spherical joint mechanism includes: a spherical protrusion formed on either of the reservoir-side joint member or the accepter-side joint member; and a spherical recess formed in the other of the two joint members that does not have the spherical protrusion, the spherical recess being of a shape complementary to the spherical protrusion.

3. The liquid send/receive joint device according to claim 2, wherein a seal member is provided in at least one of the spherical protrusion and the spherical recess.

4. The liquid send/receive joint device according to claim 3, wherein the seal member is placed at a position slightly off-center on the spherical protrusion and the spherical recess.

5. The liquid send/receive joint device according to claim 2, wherein at least one of the spherical protrusion and the spherical recess is made of an elastic member, and the elasticity of the elastic member keeps an area between the spherical protrusion and the spherical recess watertight.

6. A fuel cell system comprising:
a fuel cell;
a liquid reservoir containing liquid fuel;
a liquid accepter for receiving the liquid fuel from the liquid reservoir and supplying it to the fuel cell; and
the liquid send/receive joint device described in any one of claims 1 to 5.
